(19) United States
(12) Patent Application Publication
(10) Pub. No.: US 2019/0318672 A1
(43) Pub. Date: Oct. 17, 2019

(54) Printed Frame and Artwork with Depth Indicia

(71) Applicant: Kamran Deljou, Atlanta, GA (US)

(72) Inventor: Kamran Deljou, Atlanta, GA (US)

(21) Appl. No.: 16/453,526

(22) Filed: Jun. 26, 2019

Related U.S. Application Data
(63) Continuation-in-part of application No. 16/122,260, filed on Sep. 5, 2018.
(60) Provisional application No. 62/559,092, filed on Sep. 15, 2017.

(51) Int. Cl. G09F 15/00; A47G 1/06; G09F 15/02; B41M 5/00

(52) U.S. Cl. CPC G09F 15/0012; B41M 5/0041; G09F 15/02; A47G 1/06

(57) ABSTRACT

A display for mounting in a location subject to subject-sensitive ambient lighting includes a substrate. An artwork image, a molding image and a shadow image are printed on the substrate. A gap area is defined between an inside edge of the molding image and an outside edge of the artwork image so as to appear as a floater frame. The shadow image appears as an actual shadow in a real floater frame that has been subject to the subject-sensitive ambient lighting. The substrate is mounted on a stretcher bar frame. In a method of generating a display, a digital image of a molding assembled into a floater frame, an artwork, and a shadow that would appear in a real floater frame that has been subject to the subject-sensitive ambient lighting is generated. The digital image is printed onto a substrate. The substrate is mounted onto a stretcher bar frame.

### CROSS-REFERENCE TO RELATED APPLICATION(S)

This application claims the benefit of U.S. Provisional Patent Application Ser. No. 62/559,092, filed Sep. 15, 2017, the entirety of which is hereby incorporated herein by reference.

This application is a continuation-in-part of, and claims the benefit of, U.S. patent application Ser. No. 16/122,260, filed Sep. 5, 2018, the entirety of which is hereby incorporated herein by reference.

### BACKGROUND OF THE INVENTION

### 1. Field of the Invention

The present invention relates to art production processes and, more specifically, to a system for adding images of frames to printed artwork.

### 2. Description of the Related Art

Individuals, businesses, institutions, such as hotels and the like, display art work in their living environments. While some of the artwork is original, much of it includes printed copies of original artwork. Frequently, such artwork is duplicated via printing on canvases or other substrates to give it an original “feel” to multiple copies. The printed artwork is then mounted and framed.

Framing artwork can be quite expensive when many copies are produced. For example, many hotels have over 500 rooms. When a hotel places four prints in each room, over 2,000 prints must be mounted and framed. The resulting cost just for the framing alone can be in the hundreds of thousands of dollars.

In the alternative, some prints are wrapped around a frame (such as a wooden frame or a stretching bar, also known as a backing frame) in what is referred to as a “stretched canvas” and/or a “gallery wrap.” In a gallery wrap, part of the print is wrapped around the sides of the frame. However, a gallery wrap does not lend itself well aesthetically to certain genres of prints. For example, many people do not want gallery wrapped prints of renaissance artwork, nature scenes and the like.

Therefore, there is a need for a process for presenting an image of framed artwork without incurring the cost of framing.

### SUMMARY OF THE INVENTION

The disadvantages of the prior art are overcome by the present invention which, in one aspect, is a method of generating a print, in which an image of at least one work of art is scanned, thereby generating a digital image of the artwork. An image of at least one frame molding is scanned, thereby generating a digital image of the molding. The artwork digital image is combined with the molding digital image, thereby generating a combined image of the work of art surrounded by a frame made of the molding. The combined image is printed onto a substrate.

In another aspect, the invention is a system for generating printed artwork that includes an art scanner that is configured to multi-dimensionally scan works of art, thereby generating digital artwork images thereof. A molding scanner is configured to multi-dimensionally scan moldings, thereby generating digital molding images thereof. A computer is programmed to combine at least one of the digital artwork images with at least one digital molding image, thereby generating a combined digital image that include an image of one of the works of art surrounded by an image of a frame made from one of the moldings. A printer prints in multiple dimensions the combined digital image onto a selected substrate.

In another aspect, the invention is a display for mounting in a location subject to subject-sensitive ambient lighting that includes a substrate. An artwork image is printed on the substrate. A molding image is printed on the substrate about the artwork image. A gap area is defined between an inside edge of the molding image and an outside edge of the artwork image so as to appear as a floater frame. A shadow image is printed on the substrate in the gap area. The shadow image has an appearance of an actual shadow in a real floater frame that has been subject to the subject-sensitive ambient lighting. The substrate is mounted on a stretcher bar frame.

In another aspect, the invention is a method of generating a display for mounting in a location subject to subject-sensitive ambient lighting, in which a digital image of a molding assembled into a floater frame is generated. A digital image of an artwork is generated. A digital image of a shadow that would appear in an actual floater frame that has been subject to the subject-sensitive ambient lighting is generated. The digital image of the molding, the digital image of the artwork and the digital image of the shadow are printed onto a substrate. The substrate is mounted onto a stretcher bar frame.

In yet another aspect, the invention is a method of generating a display, in which a digital image of a complex frame is generated. The digital image of the complex frame is combined with a digital image of an artwork so as to generate a display image. The display image is printed on a substrate. The substrate is mounted on a stretcher bar frame.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a molding scanning system.

FIG. 2 is a schematic diagram of an artwork scanning system.

FIG. 3 is a schematic diagram of a combined image printing system.

FIGS. 4A-4D are schematic diagrams showing digital images of moldings/mattes being assembled into an image of a frame.

FIGS. 5A-5E are schematic diagrams showing a process of selecting artwork images, moldings/mattes, substrates and combining them onto a final digital file for sale or print.

FIG. 6 is a flowchart demonstrating one representative method of generating prints that include the image of a frame.

FIGS. 7A-7D are schematic diagrams demonstrating a method of printing a frame image onto any material applied adhesively, such as tape and then applying the material to an artwork, print or original.

FIG. 8 is a schematic diagram of an embodiment in which a frame image is printed onto a mirror or other reflective surface.

FIGS. 9A-9D is a series of photographs and details thereof of a display with depth indicia printed thereon.

FIGS. 10A-10B is a series of photographs showing a display with an image of a lighting element printed thereon.

FIGS. 11A-11B is a series of color photographs showing a display with an image of color reflections printed on an image of a frame.

FIG. 12 is a photograph of a display with an image of a side of a frame printed thereon.

FIG. 13 is a photograph of a display with an image of a complex frame printed thereon.

FIG. 14 is a schematic diagram of one apparatus for capturing an image of a floater frame with depth indicia.

FIG. 15A is a photograph of a substrate with an image of a frame and an image of a first artwork printed thereon.

FIG. 15B is a photograph of a substrate with an image of a frame and an image of a second artwork printed thereon.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, “artwork” includes any tangible aesthetic expression of authorship, examples of which include: paintings, drawings, sketches, photographs, prints, sculptural works, etc.

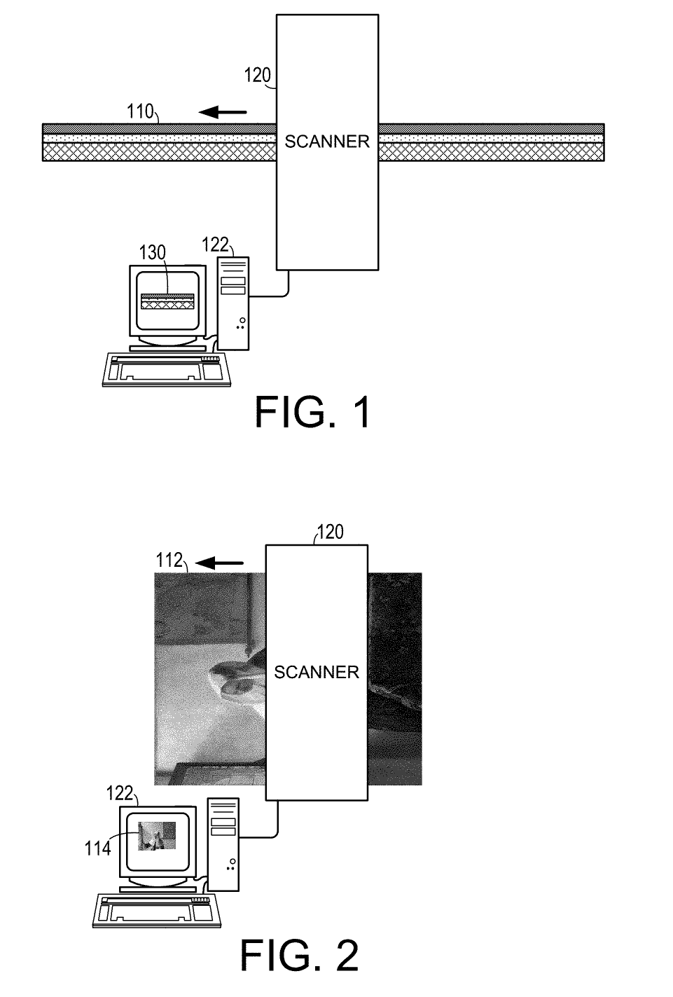

As shown in FIG. 1, in one embodiment of the invention, a scanner 120, which is in data communication with a computer 122 that includes a non-volatile memory and a display device, is used to scan a piece of molding 110 of the type that is typically employed in a picture frame and stores a digital image 130 of the molding 110. The scanner 120 can also scan a matte board, including a beveled matte. In one embodiment, the scanner 120 senses and records two or three dimensional information about the molding 110.

As shown in FIG. 2, the scanner 120 also scans at least one original work of art 112 and stores a digital image 114 of the work of art 112. In one embodiment, the scanner 120 can sense and store two- or three-dimensional information about the work of art 112, which would indicate the texture of brush strokes and the like. There is no requirement that the scanner used to scan the molding be the same scanner used to scan the work of art.

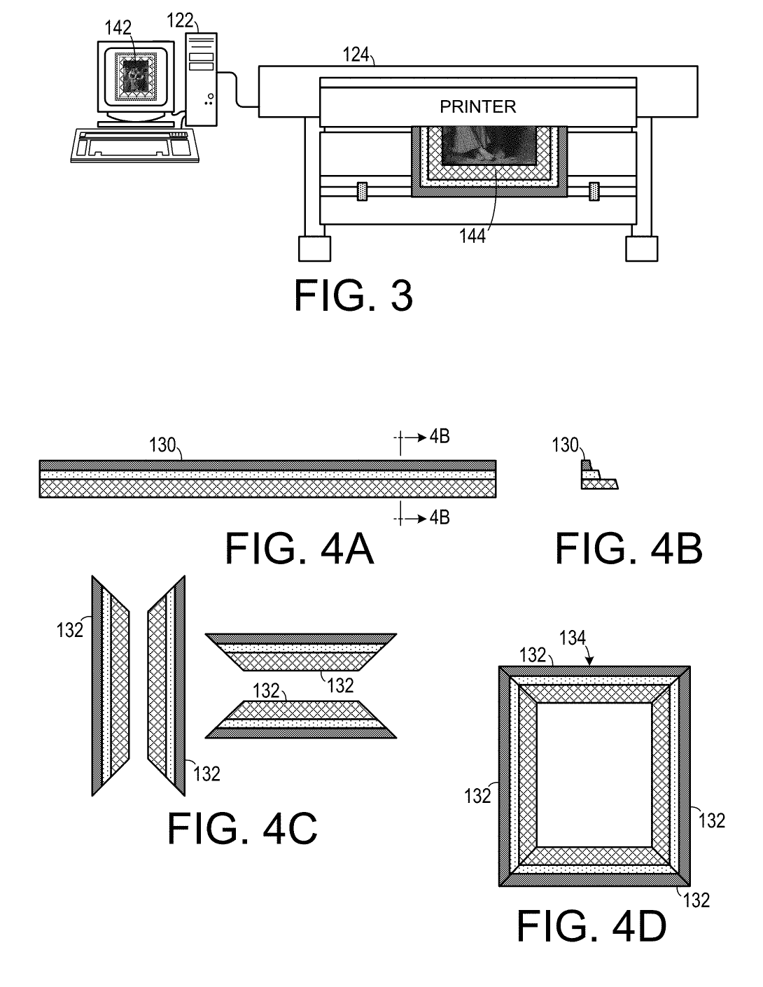

As shown in FIG. 3, the computer 122 combines the digital image of the artwork with the digital image of the molding (and any matte material that is desired) into a combined image 142. (It should be noted that the digital images need not have been sourced from scanning only.) The combined image is printed onto a substrate with a printer 124 (such as an ink jet printer) to generate an image 144 that appears to be framed. The substrate can be one of many different materials, depending upon the specific application. For example, the substrate could include: a flexible canvas material, a rigid plastic, a flexible plastic, a metal, a wood product, a fiberboard, a glass material, a mirror, etc. If the printer is a three dimensional printer, it can print the frame in relief and can also print the texture of the brush strokes in the art work.

As shown in FIGS. 4A-4D, the scanned molding 130 (which can be a three dimensional image, as shown in FIG. 4B) can be manipulated by the computer to generate a plurality of molding segments 132, each having a length that corresponds to the outer edges of the work of art. The segments 132 are then assembled to form a frame image 134. In certain embodiments, the molding images can be sourced from a non-scanned image source.

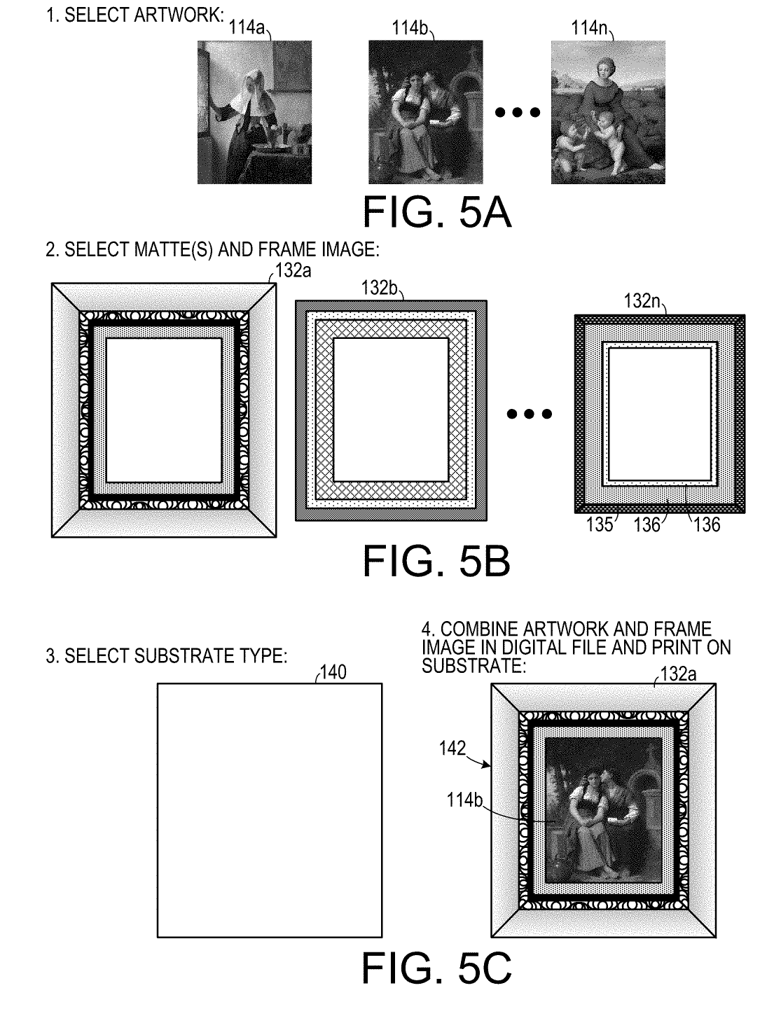

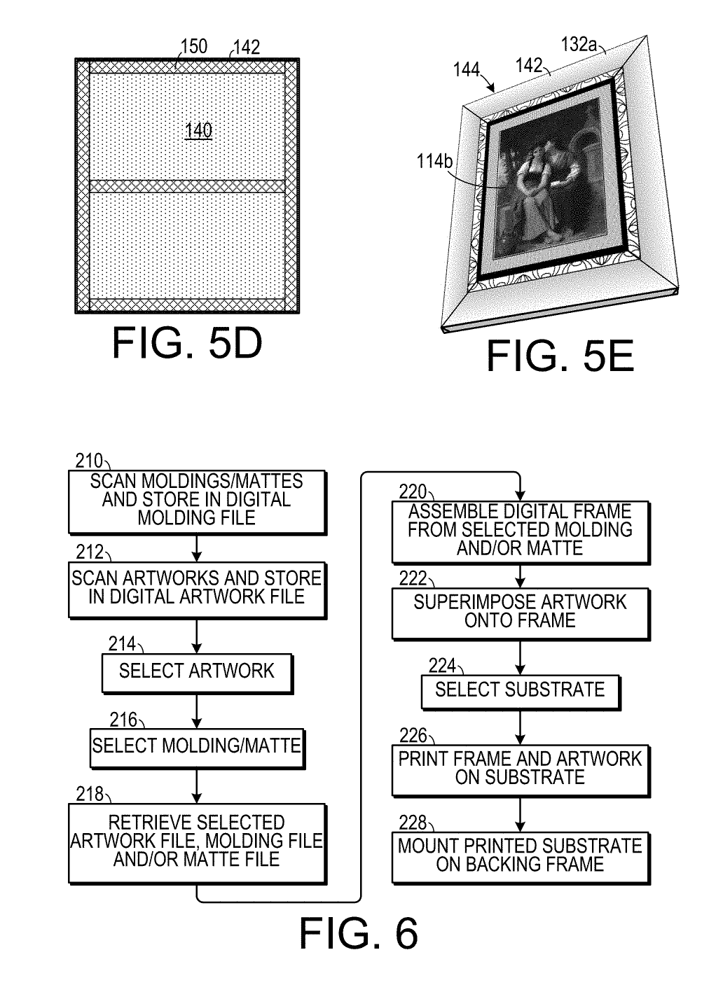

In one practical embodiment, a user selects from several different digital images 114a-n of works of art, as shown in FIG. 5A. The user also selects from different frame styles 132a-n, as shown in FIG. 5B. The frame style may include the image of at least one molding 135 and one or more matte styles 136 (which can include beveled mattes). As shown in FIG. 5C, the desired substrate type 140 is selected. The selected artwork image 114b and the selected frame/matte image 132a are printed onto the substrate to generate the print 142.

As shown in FIG. 5D, the print 142 can be mounted on a frame 150, such as a wooden “stretcher bar” frame, if the substrate 140 is made of a flexible material. This results in what appears to be a framed work of art 144 ready for display, as shown in FIG. 5E.

As shown in FIG. 6, in one method for generating a framed print, of the type disclosed above, moldings and mattes are scanned and stored in a digital file 210. In certain embodiments, they can be imported, sourced or digitally created. Works of art, such as paintings and the like, are scanned and stored in a digital file 212. The user selects an artwork 214 and a combination of molding and mattes 216. The digital images of the artwork, the molding and mattes are retrieved 218 from memory. The molding and any desired mattes images are assembled to generate an image of a frame 220, which is superimposed onto the image of the artwork 222 and stored in a combined image file. The substrate is selected 224 and the combined image is printed on the substrate 226 resulting in the final print. The final print is then stretched and/or mounted, if necessary, onto a backing frame 228. (It will be understood that when the images are printed on certain substrates, such as rigid substrates, the backing frame may not be necessary.)

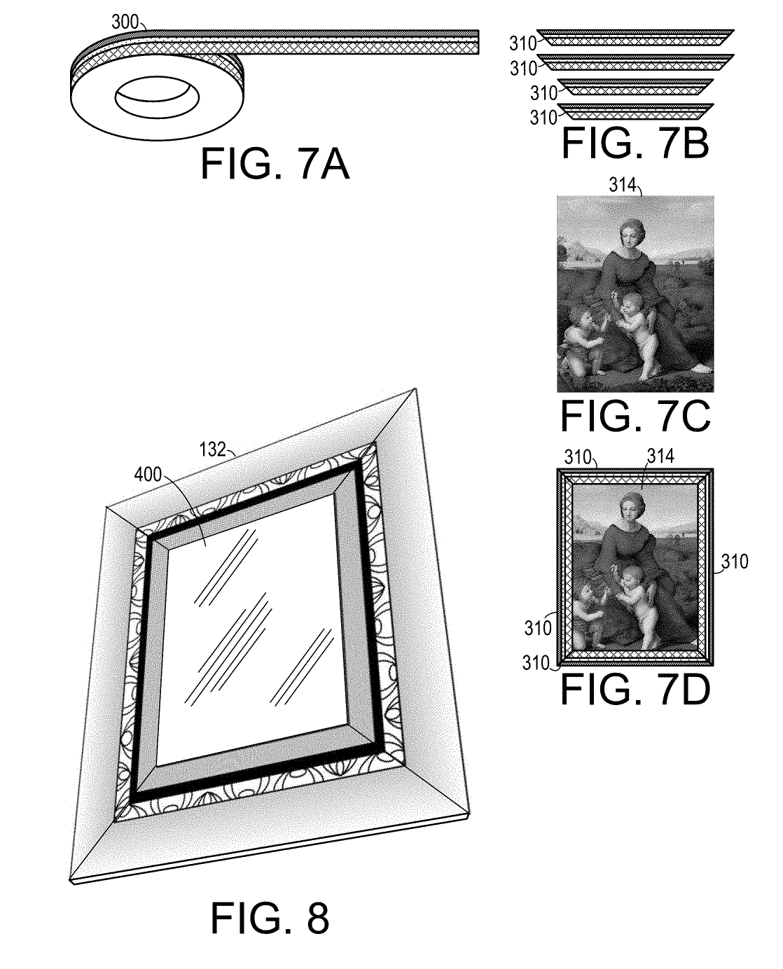

In one embodiment, as shown in FIG. 7A, the moldings and any desired mattes can be printed on a roll of spooled substrate 300. As shown in FIG. 7B, framing segments 310 can be cut from the roll of spooled substrate 300 and applied or affixed to an existing original work or print 314, as shown in FIG. 7C, thereby giving the existing original work or print 314 a framed look, as shown in FIG. 7D. In one embodiment, the molding image may be printed on a tape to which an adhesive (such as a pressure-sensitive adhesive) may subsequently be applied.

As shown in FIG. 8, in one embodiment, a frame image 132 can be printed on a glossy object, or a reflective surface such as a mirror 400, thereby giving the mirror 400 a framed appearance.

As used herein, “floater frame” means a frame made of a molding in which a work is mounted wherein there is a gap between the outermost edges of the work and the innermost edges of the molding so that the work appears to float inside of the molding. Floater frames are also commonly referred to a “float frames” and “floating frames.” Also, as used herein, “subject-sensitive ambient lighting” includes the lighting by which a subject artwork is expected to be illuminated during normal display of the subject artwork. A stretcher-bar frame is typically a wooden frame onto which is mounted a substrate such as a canvas (or other type of printable substrate) and it is typically not seen in the final display.

It is important to note that, while the following figures appear as real three-dimensional floater frames with artworks mounted therein, they actually show canvases onto which images of frames, artworks and shadows are printed thereon. The images of frames can be two-dimensional images, images with added texture printed thereon and images with three-dimensional printing. The substrates are then mounted on stretcher-bar frames to give rise to the illusion of real three-dimensional frames and artworks.

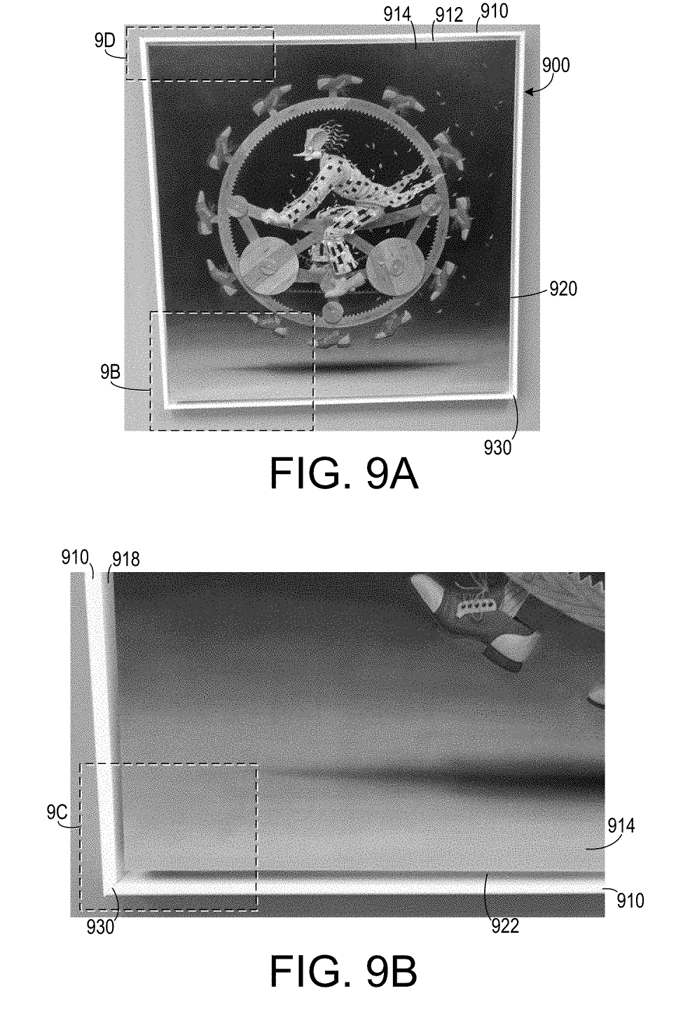

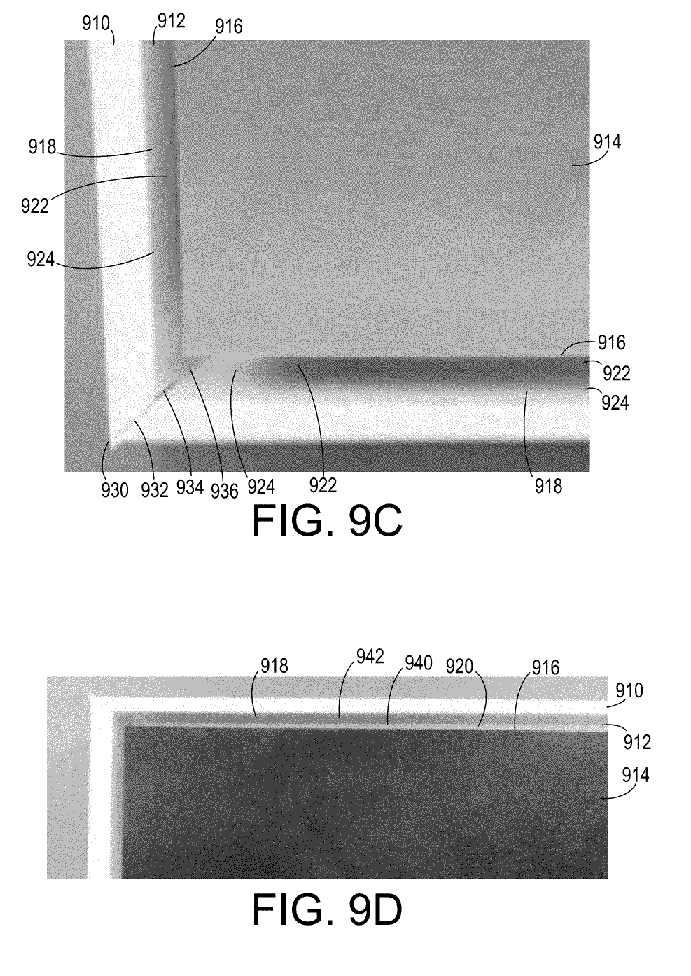

As shown in FIGS. 9A-9D, in one embodiment a display 900 includes a substrate 920 upon which is printed an image of a molding assembled into an image of a floater frame 910 and an image of an artwork 914 that appears to be disposed in the image of the floater frame 910. Also, as seen in greater detail in FIG. 9B (which corresponds to item 9B in FIG. 9A) an image of a gap area 912 is printed on the substrate 920 so that it appears to be between the image of an edge 916 of the artwork 914 and the image of the floater frame 910. The image of the gap area 912 can include images of inside surfaces of the molding and a back surface region. A shadow image 918 is printed in the gap area 912 to create an illusion of depth between the image of the artwork 914 and the image of the floater frame 910. The shadow image 918 can include regions of higher shadow density 922 flowing into regions of lower shadow density 924 so as to have the appearance of an actual shadow in a real floater frame that has been subject to the subject-sensitive ambient lighting (i.e., the lighting that corresponds to the ambient lighting on the wall on which the display 900 is to be mounted) as seen from the perspective of an ordinary viewer of the display 900.

As seen in greater detail in FIG. 9C (which corresponds to item 9C shown in FIG. 9B), an image of a molding joint 932 at the corners 930 of the image of the frame 910 may be printed on the substrate 920. The image of the molding joint 932 would typically correspond to the image of a joint between two moldings that do not fit seamlessly and can include a front shadow image 932 that appears to have a space between the two moldings and an inside image 934 that would correspond to what would be seen in a real frame joint from the perspective of a viewer of the artwork. The inside image 934 can include a gap area fading into a portion of what appears as a tightly fit portion 936 of a joint between two moldings.

An upper frame detail (which corresponds to item 9D in FIG. 9A) is shown in FIG. 9D, in which the image of shadowing on an inside upper molding portion 942 is printed on the substrate 920 and a back surface image 940 is printed between the inside upper molding portion 942 and the image of the edge 916 of the image of the artwork 914.

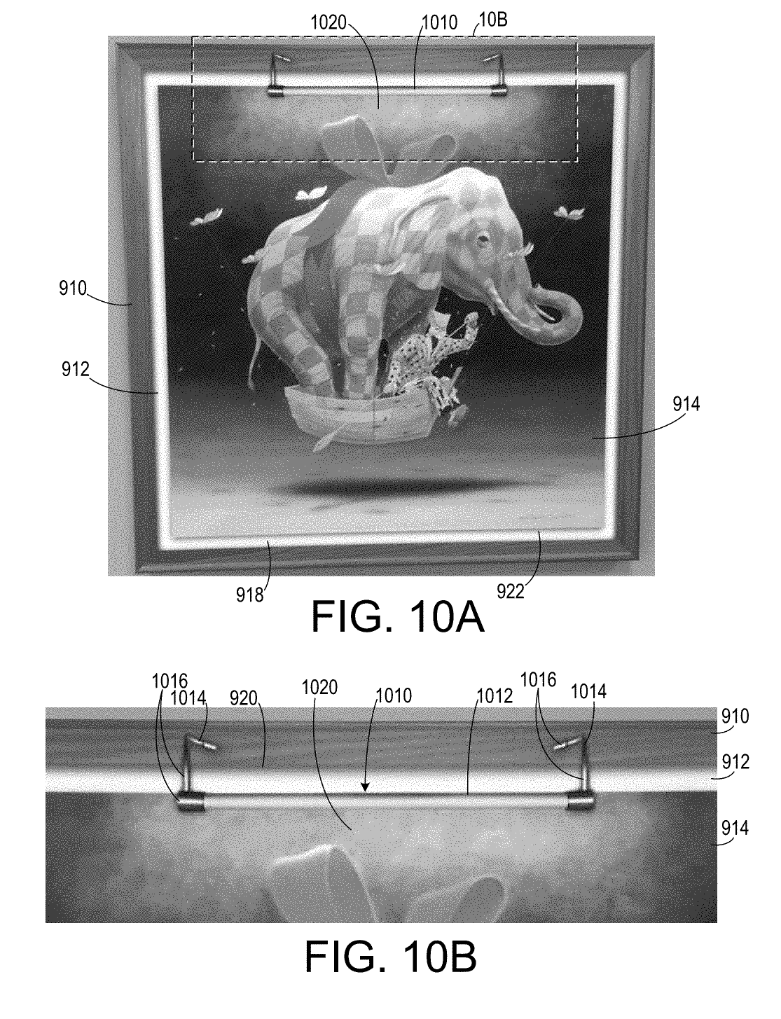

As shown in FIGS. 10A and 10B, an image of a lighting element 1010 can be printed on the substrate so as to appear as a real lighting element that has been mounted on an actual floater frame. An area 1020 that has an appearance of light from the real lighting element reflecting from the artwork can be printed in the region where one would expect to see light from the lighting element. This area 1020 would typically be printed with the same colors and hues as that of the artwork in the region, but with a brighter ink that fades into normal brightness as it gets away from the image of the lighting element 1010. Typically, the image of the lighting element 1010 would be printed in such a way so that the perspective of its elements would correspond to the perspective seen by a viewer of the artwork standing away from the artwork at a normal distance and looking at it from directly in front of the artwork.

The image of the lighting element 1010 can be seen in better detail in FIG. 10B, (which corresponds to item 10B in FIG. 10A). The lighting element image 1010 can include an image of a light bulb 1012 being supported by an image of a lighting fixture 1014. If the image of the lighting fixture 1014 corresponds to a metallic lighting fixture, then lighter highlights 1016 may be printed on the image of a lighting fixture 1014 to give it a metallic appearance. Also, the highlights 1016 can be printed with a glossy coating to make it look more realistic.

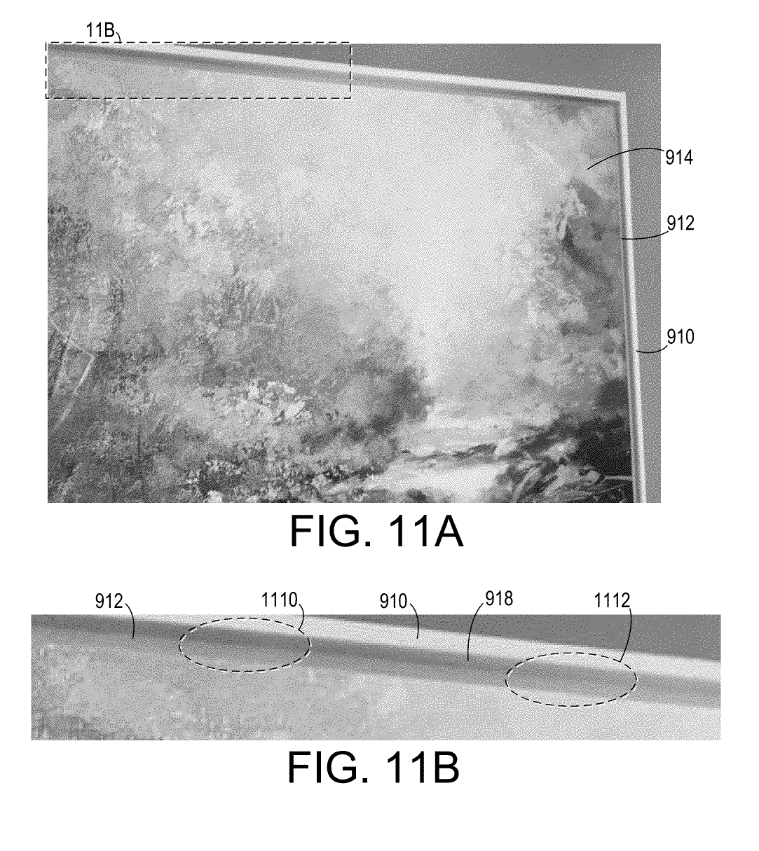

As shown in FIGS. 11A and 11B (in which FIG. 11B corresponds to item 11B in FIG. 11A), a reflection image 1110 and 1112 can printed on a portion of the substrate in the gap area 912 so that it looks like an expected reflection from a real artwork corresponding to the artwork image 914. The reflection image 1110 and 1112 includes colors that appear in a portion of the artwork image 914 near the frame molding. As can be seen in FIG. 11A, reflection image 1110 includes an orange tinge added to the shadow image, which corresponds to the local orange in the artwork image 914, and reflection image 1112 includes a yellow tinge added to the shadow image, which corresponds to the local yellow in the artwork image 914. The reflection image 1110 and 1112 should match the hue and saturation of the area of the artwork near the edge and should have a density that varies according to an actual reflection of light from the artwork image 914.

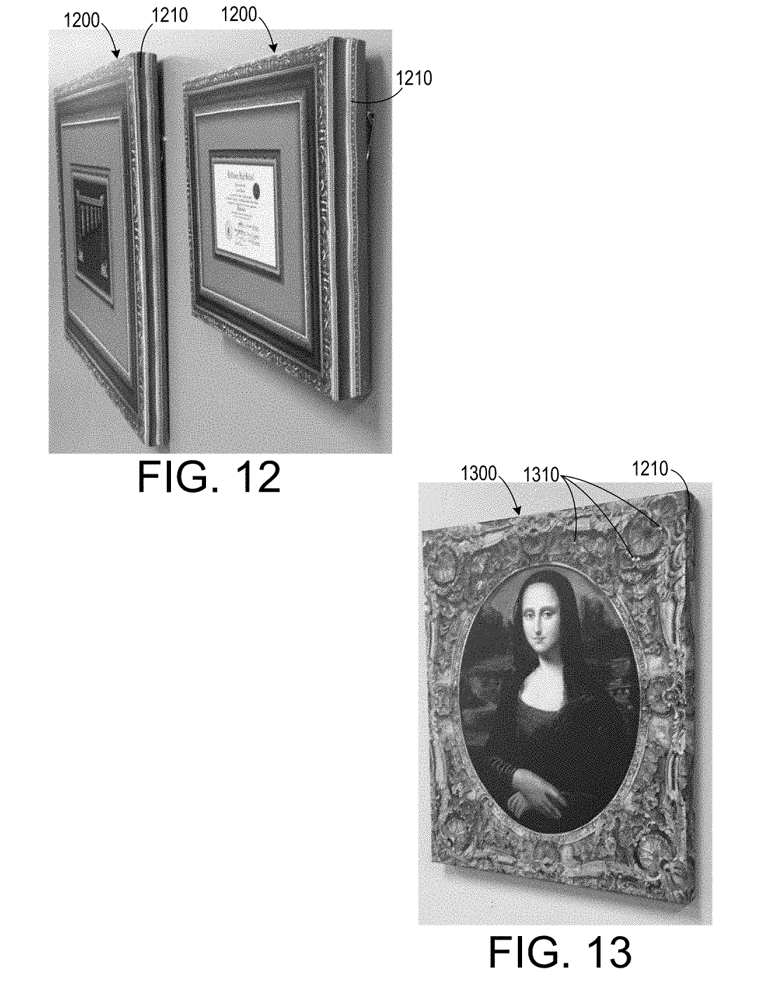

A more complex display 1200, as shown in FIG. 12, can include an image of a molding edge 1210 printed on a region of the substrate so that when the substrate is mounted on the stretcher bar frame, a side of the display 1200 appears to have a side edge of the real molding. Also, as shown in FIG. 13, the image of a complex molding 1300 can be printed onto the display. Complex moldings include moldings that include non-linear three dimensional sculptural devices in the molding (such as the one shown). Such a complex molding image 1300 can include printed textures and highlights 1310, on which can be added a glossy coating so as to give the printed image of the molding a more realistic appearance.

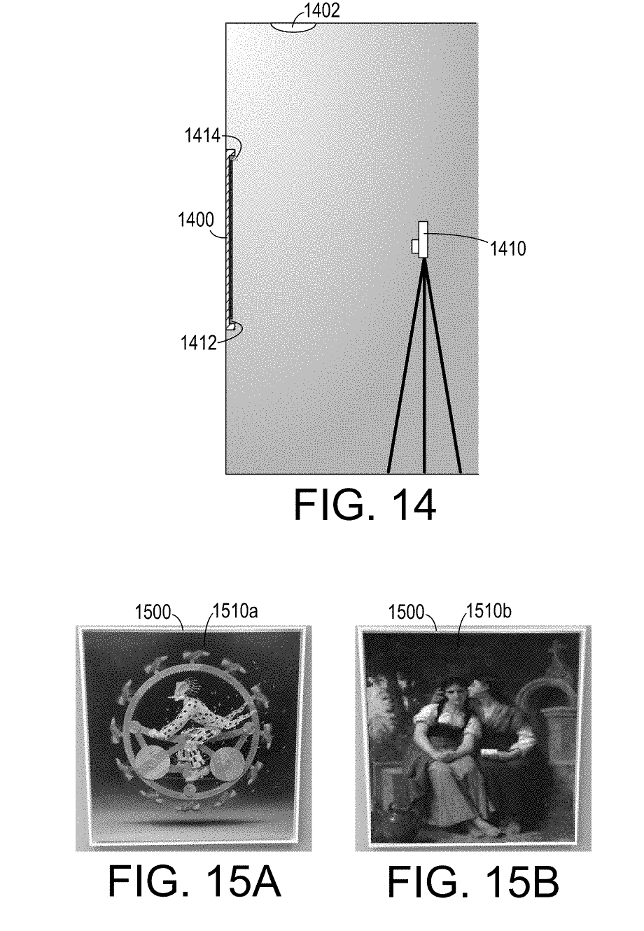

As shown in FIG. 14, one way to determine the qualities of the shadows is to photograph with a digital camera 1410 an actual frame 1400 with an artwork disposed therein while subject to the light 1402 to which the resulting display will be subject once mounted on a wall. The photograph is typically taken at a distance and at a height relative to the frame 1400 that a viewer is expected to in relation to the display during normal viewing. The images of the shadows 1412, the reflections 1414 and the frame 1400 can be digitally added to any desired artwork and then printed on a substrate. As shown in FIG. 15A, a frame image 1500 can be combined with a first artwork image 1510a or, as shown in FIG. 15B frame image 1500 can be combined with a second artwork image 1510b. Thus, one frame image may be combined with many different artwork images. In an alternate method, a computer employing a graphics program with ray tracing capabilities can be used to generate the shadow images and the reflection images. There are many commonly-available graphics software packages with ray tracing capability known to those of skill in the art.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A display for mounting in a location subject to subject-sensitive ambient lighting, comprising:
(a) a substrate;
(b) an artwork image printed on the substrate;
(c) a molding image printed on the substrate about the artwork image, a gap area defined between an inside edge of the molding image and an outside edge of the artwork image so as to appear as a floater frame;
(d) a shadow image printed on the substrate in the gap area, the shadow image having an appearance of an actual shadow in a real floater frame that has been subject to the subject-sensitive ambient lighting; and
(e) a stretcher bar frame onto which the substrate is mounted.

2. The display of claim 1, further comprising an image of at least one molding joint printed on a corner of the substrate that includes an image of a shadow associated with a corresponding molding joint in the real floater frame.

3. The display of claim 1, further comprising an image of a lighting element printed on the substrate so as to appear as a real lighting element that has been mounted on a real floater frame.

4. The display of claim 3, further comprising an area printed on the substrate that has an appearance of light from the real lighting element reflecting from the artwork image.

5. The display of claim 1, further comprising a reflection image printed on a portion of the substrate in the gap area, the reflection image having an appearance of an expected reflection from a real artwork corresponding to the artwork image onto the a real floater frame that has been subject to the subject-sensitive ambient lighting.

6. The display of claim 5, wherein the reflection image includes colors that appear in a portion of the artwork image.

7. The display of claim 1, further comprising at least one molding edge image having an appearance of a side edge of a real molding printed on at least one edge of the substrate so that when the substrate is mounted on the stretcher bar frame, a side of the display appears to have a side edge of the real molding.

8. The display of claim 1, further comprising:
(a) a texture printed on at least a portion of the molding image; and
(b) a glossy coating printed on at least a portion of the texture.

9. A method of generating a display for mounting in a location subject to subject-sensitive ambient lighting, comprising the steps of:
(a) generating a digital image of a molding assembled into a digital image of a floater frame;
(b) generating a digital image of an artwork;
(c) generating of a digital image of a shadow that would appear in an actual floater frame that has been subject to the subject-sensitive ambient lighting;
(d) printing the digital image of the floater frame, the digital image of the artwork and the digital image of the shadow onto a substrate; and
(e) mounting the substrate onto a stretcher bar frame.

10. The method of claim 9, wherein the step of generating of a digital image of a shadow comprises digitally photographing an actual artwork mounted in a floater frame and subject to the subject-sensitive ambient lighting.

11. The method of claim 9, wherein the step of generating of a digital image of a shadow comprises employing a graphics program with ray tracing capability to simulate an actual artwork mounted in a floater frame and subject to the subject-sensitive ambient lighting.

12. The method of claim 9, further comprising the steps of:
(a) generating a digital image of at least one molding joint having a shadow associated with a corresponding molding joint in the real floater frame; and
(b) printing the image of the at least one molding joint adjacent to a corner of the substrate.

13. The method of claim 9, further comprising the steps of:
(a) generating a digital image of a lighting element corresponding to a real lighting element mounted on a real floater frame; and
(b) printing the image of the lighting element onto the substrate.

14. The method of claim 13, further comprising the steps of:
(a) generating a digital image of a reflectance area that corresponds to light from the real lighting element reflecting from the artwork image; and
(b) printing the reflectance area onto the substrate.

15. The method of claim 13, further comprising the steps of:
(a) generating a digital metallic image on at least a portion of the image of the lighting element so that the metallic image appears in areas of expected metallic reflectance from the lighting element; and
(b) printing a glossy coating on at least a portion of the metallic image.

16. The method of claim 9, further comprising the steps of:
(a) generating a digital reflection image that has an appearance of an expected reflection from a real artwork corresponding on a real floater frame that has been subject to the subject-sensitive ambient lighting; and
(b) printing the digital reflection image onto the substrate.

17. The method of claim 16, wherein the step of generating a digital reflection image includes generating colors that appear in a portion of the artwork image.

18. The method of claim 9, further comprising the steps of:
(a) generating a digital image of at least one molding edge; and
(b) printing the image of at least one molding edge onto the substrate so that a side of the display includes a portion having an appearance of a side edge of a real molding when the substrate is mounted on the stretcher bar frame.

19. A method of generating a display, comprising the steps of:
(a) generating a digital image of a complex frame;
(b) combining the digital image of the complex frame with a digital image of an artwork so as to generate a display image;
(c) printing the display image on a substrate; and
(d) mounting the substrate on a stretcher bar frame.

20. The method of claim 19, further comprising the step of:
(a) printing a texture on at least a portion of the complex frame; and
(b) printing a glossy coating on at least a portion of the texture.
